(19) United States
(12) Patent Application Publication
(10) Pub. No.: US 2015/0178260 A1
(43) Pub. Date: Jun. 25, 2015

(54) MULTI-LAYERED PRESENTATION AND MECHANISMS FOR COLLABORATING WITH THE SAME

(71) Applicant: Avaya, Inc., Basking Ridge, CO (US)

(72) Inventor: Gordon R. Brunson, Broomfield, CO (US)

(73) Assignee: Avaya, Inc., Basking Ridge, CO (US)

(21) Appl. No.: 14/137,428

(22) Filed: Dec. 20, 2013

(51) Int. Cl. G06F 17/24; G06F 3/0484

(52) U.S. Cl. CPC G06F 17/241; G06F 3/04842

(57) ABSTRACT

Webconferences are streamed presentations generally containing video and audio portions. Layering the visual aspects of the presentation allows the streamed content to be displayed on a background layer. Embodiments are provided by which a captured image is created of a particular scene. The image is held on the display for a viewer to annotations. The image is presented in a layer on top of the background layer thereby freezing a live presentation. When the user has completed their annotations, the next scene is displayed and additional annotations may be applied to the next scene. A composite presentation file may then be saved at the end of the webconference containing local annotations and/or public presentation material. Alternatively, the layer with the captured image is hidden and live content of the background image redisplayed.

### FIELD OF THE DISCLOSURE

The present disclosure is generally directed toward communications and more particularly toward webconferencing solutions.

### BACKGROUND

Webconferencing and audio conferences have become a viable alternative to face-to-face meetings. While there are many advantages to avoiding face-to-face meetings, there are obviously many drawbacks and difficulties to conducting a meeting with multiple participants in multiple different locations. These drawbacks are amplified for large meetings (i.e., meetings with a large number of participants), especially when the meetings become interactive. In particular, it is easy to conduct a large meeting if only one person (e.g., the meeting moderator) maintains exclusive control over the entire proceedings. Interactive meetings, on the other hand, have many complications, especially when the participants are not situated in the same room.

### SUMMARY

It is with respect to the above issues and other problems that the embodiments presented herein were contemplated.

Many times during a multi-media conference (e.g., webconference, collaboration session, etc.), the conference moderator has control over information displayed to the other participants (e.g., which slide is being viewed from a power point, which page of a document is currently being shared to the conference, etc.). A problem arises when one of the non-moderator participants is trying to take notes related to the currently-shared page and the moderator switches the page or view before the note-taking participant is allowed to save their version of the presentation (e.g., their notes superimposed over the slide that was being viewed during the note-taking) Ultimately, the note-taking participant may save their own version of the notes, but if the note-taking participant cannot save their notes with the appropriate slide, the notes are rendered less useful, both to the note-taking participant as well as to the other participants if the notes are later shared.

To address this problem, certain embodiments described herein provide a multi-layered webconferencing tool or application. A first layer (or view) in the webconference may correspond to a public layer (i.e., the layer controlled by the moderator having the presentation selected by the moderator). A second layer in the webconference may correspond to a private layer, which means that each participant may have their own private layer to control their own view to render current or past shared content, (or future content, if presentation material has been pre-shared) for their own personal reference and/or note taking during the presentation. The second layer may at times be superimposed over the first layer for ease of display and use, or a public/local control may indicate which layer is rendering. If the participant is not performing some local activity in the window of the webconference, the second layer may be transparent, thereby allowing the entire first layer to be presented in a conventional manner. The webconference may further include a third layer, which may correspond to a local annotation or note-taking layer. This third layer may be superimposed over the first and second layers. The third layer may generate a multipage local document containing publicly presented material and local notes, private commentary, ink mark-up, etc. Once a participant begins taking notes in the third layer, a snapshot of the first layer may be taken and displayed in the second layer. As long as the moderator doesn't change the first layer, the participant will still only see the presentation in its original form. However, if the moderator switches slides or views in the first layer, the second layer retains the public image of the first layer associated with the start of note-taking, while the third-layer continues to be used to capture the notes and annotations of the local participant. The participant can finish taking their notes and then save those notes combined with the snapshot in the second layer. These notes can then be saved for later use or shared among the other participants after the meeting. Such saved notes may even be shared later on in the meeting as public first-layer contents for others to see if the user so chooses.

While the presentation in the second layer is different from the first layer, a number of viewing options may be exercised. For instance, the second layer may be totally opaque, thereby blocking view of the first layer, but an indicator may be provided in the second layer saying that the group's presentation view has changed. As another example, the second layer may be translucent showing some or all of the first layer in combination with the second layer. The manner in which the two layers are presented can vary and any type of presentation scheme can be utilized. Regardless of implementation, it is envisioned that the second layer keeps a snapshot of the first layer based on the point in time when the non-moderator participant starts taking personal notes. This allows the note-taking participant to keep taking useful notes without interrupting the moderator or asking the moderator to go back and re-present the old view in the first layer. When the participant selects the public view again, their notes and previous view are saved and appended to a local document which may be followed by any new public views. The second layer is allowed to be transparent again, thereby bringing the participant back to the current view controlled by the moderator. The saved local document becomes a collection of publicly presented material, collated with all local notes and annotations.

In another embodiment a fourth layer may present a public annotation layer utilized by one or more participants or moderator of the presentations to capture and publicly share notes and annotations on visual aspects of the presentation. If a fourth layer is implemented, then the contents of both the first and fourth layers are “captured” to the second layer as the background for annotation whenever local note-taking begins.

The moderator may have control over the public layers (i.e., first layer and fourth layer), whereas the private layers (e.g., second layer and third layer) may be solely controlled by each participant. This allows each participant to maintain their perspective of the presentation, save useful notes in association with the appropriate slides viewed on the first layer, and save those notes in a useful manner.

In one embodiment, a method is disclosed, comprising displaying a real-time presentation on a real-time presentation layer, the real-time presentation comprising at least a visual portion; detecting a user input; capturing, in response to the detected user input, an image substantially corresponding to the real-time presentation layer and displaying the image in an annotation layer; enabling a user to provide annotations on the annotation layer; and displaying the annotation layer on top of the real-time presentation layer.

In another embodiment, a computing system is disclosed, comprising: a network interface operable to receive a real-time presentation comprising at least a visual portion; a video display component; a user input component; and a processor operable to display the visual portion in a real-time presentation layer, capture an image substantially corresponding to the real-time presentation layer in response to a user input on the user input component, display the image in an annotation layer, receive user inputs associated with an annotation on the annotation layer, and display the annotation layer in front of the real-time presentation layer.

In yet another embodiment, a non-transitory medium is disclosed having thereon instructions that when read by a machine cause the machine to: display a real-time presentation on a real-time presentation layer, the real-time presentation comprising at least a visual portion; detect a user input; capture, in response to the detected user input, an image substantially corresponding to the real-time presentation layer and displaying the image in an annotation layer; enable a user to provide annotations on the annotation layer; and display the annotation layer on top of the real-time presentation layer.

The phrases “at least one,” “one or more,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The term “computer-readable medium” as used herein refers to any tangible storage that participates in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, or any other medium from which a computer can read. When the computer-readable media is configured as a database, it is to be understood that the database may be any type of database, such as relational, hierarchical, object-oriented, and/or the like. Accordingly, the disclosure is considered to include a tangible storage medium and prior art-recognized equivalents and successor media, in which the software implementations of the present disclosure are stored.

The terms “determine,” “calculate,” and “compute,” and variations thereof, as used herein, are used interchangeably and include any type of methodology, process, mathematical operation or technique.

The term “module” as used herein refers to any known or later developed hardware, software, firmware, artificial intelligence, fuzzy logic, or combination of hardware and software that is capable of performing the functionality associated with that element. Also, while the disclosure is described in terms of exemplary embodiments, it should be appreciated that other aspects of the disclosure can be separately claimed.

### BRIEF DESCRIPTION OF THE DRAWINGS

The present disclosure is described in conjunction with the appended figures:

FIG. 1 illustrates a system in accordance with embodiments of the present disclosure;

FIGS. 2A and 2B, illustrate a presentation client interface will be described in accordance with embodiments of the present disclosure;

FIG. 3 illustrates a navigation panel in accordance with embodiments of the present disclosure;

FIG. 4 illustrates a combined-layer image in accordance with embodiments of the present disclosure;

FIG. 5 illustrates a first flowchart of a method in accordance with embodiments of the present disclosure; and

FIG. 6 illustrates a second flowchart of a method in accordance with embodiments of the present disclosure.

### DETAILED DESCRIPTION

The ensuing description provides embodiments only, and is not intended to limit the scope, applicability, or configuration of the claims. Rather, the ensuing description will provide those skilled in the art with an enabling description for implementing the embodiments. It being understood that various changes may be made in the function and arrangement of elements without departing from the spirit and scope of the appended claims.

Layers are known graphical elements by which features are digitally applied to a layer and then the layer may be managed as a unit without having to manipulate the individual graphical elements. One benefit of layers allows an artist, graphic designer, or programmer to create a rich layer and selectively show or hide it. For example, a background layer may be created and selectively covered by a foreground image. In addition to specific components being shown or hidden, layer-level operations may be provided. Operations may include varying the opacity of a layer. As a benefit, a layer may show all when completely transparent, nothing when completely opaque, or any degree of transparency in between. Layers may have canvas image or color such that when a foreground layer is completely opaque, any background layers are completely hidden. Foreground layers without a canvas image or color may be opaque with respect to just the graphical elements and any location without a graphical element remains transparent to a background layer. When individual layer property manipulation is no longer required, multiple layers may be consolidated into a single final layer.

Webconferencing software, in some embodiments, allows participants to watch a presentation provided by a server, which may include another user's personal computer or similar device. The presentation may be live (e.g., real-time) communication session. Durring live presentations, participants may have the ability to interact with the presentation, such as by, asking questions or providing comments via audio link, text message/SMS message, chat messages, email, etc.

The embodiments described herein are generally directed towards annotation of a real-time webconference presentation. The real-time presentation is a streamed webconference that may be live, previously recorded, or a combination thereof whereby a moderator and not the users (e.g., participants in the webconference) determine the content, even if the content includes portions provided by a participant. Webconferences are typically comprised of a visual portion, for displaying the visual content of the webconference (e.g., video, slides, etc.), and an audio portion, such as the voice of a speaker. The visual portion may include any one or more of recorded or live motion images (e.g., video), static images, slides, application displays, text, screen-sharing images, annotations and other content which may be displayed or presented on a display of a communication device.

Live presentations, by their very nature, cannot be paused at the source by one viewing the presentation. Similarly, previously recorded presentations may be streamed to a number of viewers simultaneously. As there are more than one viewer of the presentation, it is not practical to offer client devices the ability to source-pause a presentation as it would affect the experience of all viewers. With reference to certain embodiments described herein, a client application is provided to enable a user to annotate a local snapshot of a presentation, giving the appearance to that the live presentation has been suspended. The presentation then advances when the user completes their annotations or otherwise indicates that the presentation should advance. The audio portion of the presentation may similarly be held or advanced, such as by accelerated playback or skipping portions of cached audio to catch up to a next snapshot of the video portion of the presentation or to rejoin the live presentation. Alternatively, the audio portion may continue to be the audio portion of the live presentation.

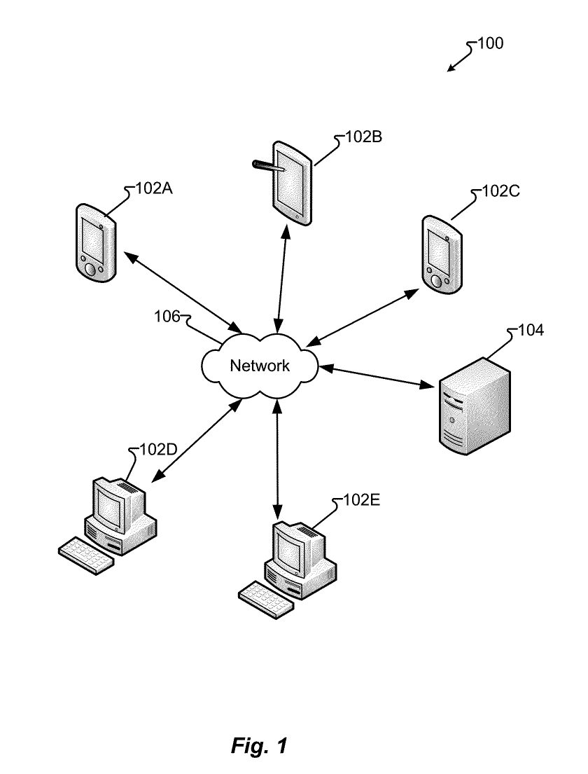

With reference now to FIG. 1 a system will be described in accordance with embodiments of the present disclosure. In one embodiment, a number of devices 102 are logically attached to network 106 to participate in a webconference. Devices 102 are variously embodied and generally comprise devices operable to receive a webconference and display visual elements on an integrated or attached display. Devices 102 include, but are not limited to, personal data assistant 102A, tablet computer 102B, smartphone 102C, and personal computers 102D, 102E (with or without web browser functionality). Devices 102 may also comprise integrated or connected speakers for the presentation of the audio portion of the collaborative session. The content of the webconference may come from one or more devices 102 and/or one or more servers 104, which are also attached to network 106.

Network 106 is shown as a single uniform entity for convenience only. While network 106 may be a single uniform entity, in other embodiments network 106 may comprise portions of one or more of, a private data network (e.g., Ethernet), public data network (e.g., Internet), wired and/or wireless (e.g., WiFi, WiMax, cellular voice and/or data, ZigBee, BlueTooth, etc.), telephone network (e.g., VoIP, public switched network, plain old telephone service, etc.) and other information networks. Network 106 may be distinct from other components 106, as shown, or integrated with one or more such components operable to convey at least the data portion of a webconference to a number of participants. Server 104 may also be attached to network 106. Server 104 may provide certain administrative and/or presentation functions of a webconference, such as, providing access to authorized users, streaming the content of the collaborative session webconference, connecting and tear-down of connections, storage of data and presentation files, etc. Server 104 may be distinct from devices 102 or integrated, in whole or in part, within one or more of devices 102.

In one embodiment, server 104 provides a real-time presentation comprising a visual portion and, optionally, an audio portion. Devices 102 display the visual portion on their respective display elements and the auto portion on their respective speakers. A user viewing a presentation on one of devices 102 may wish to take notes and have those notes associated with currently shown visual portion. However, in prior art webconferencing applications, if the real-time presentation advances, the user is force to either remember the target of the annotation or to make additional annotations so that the target can be later identified. For example, a simple annotation such as, “discuss this with the staff,” must have the target, “this,” identified in the annotations or rely on the annotators memory. This can be a burdensome and error-prone process, especially since the real-time presentation may have advanced to another topic. Therefore, with respect to certain embodiments herein, an image of the real-time presentation is captured and operable to capture an image of the real-time presentation and receive annotations associated with the captured image.

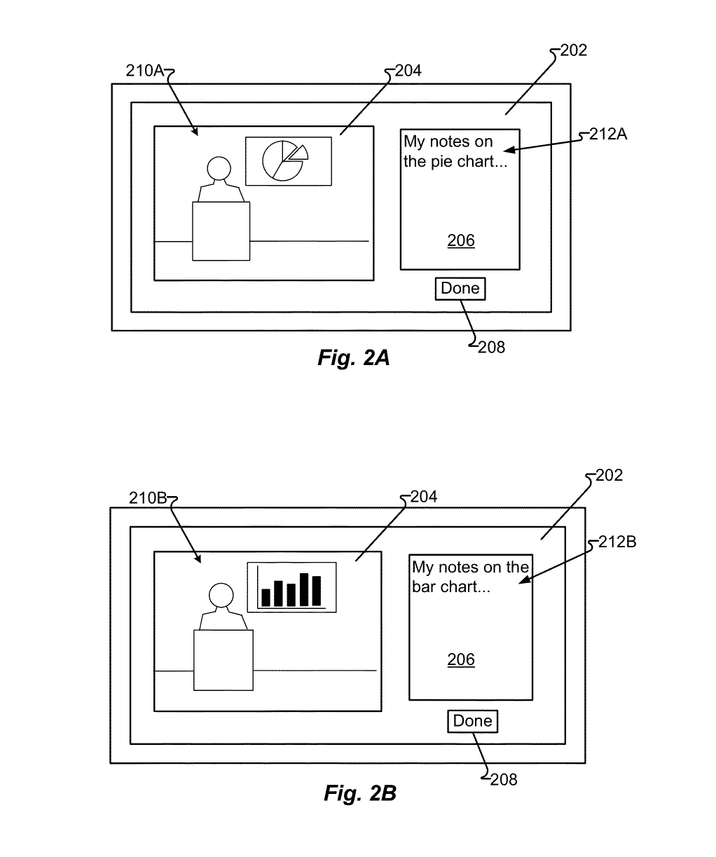

With reference now to FIGS. 2A and 2B, a presentation client interface will be described in accordance with embodiments of the present disclosure. In one embodiment, display 202 is a display of at least one of devices 102. Presentation window 204 displays the visual content of the webconference, such as scenes 210A and 210B. In one embodiment, notepad 206 allows a user to type notes 212A associated with scene 110A.

In another embodiment, notepad 206 may partially or entirely overlap presentation window 204, such as to allow for annotations to be “pinned to” particular locations within the area of the scene 210A within the presentation window 204. In a further embodiment, notepad 206 may allow for drawing, inking and/or typing of annotations, such as with keyboard, a finger or stylus on a touch-sensitive display associated with PDA 102A, tablet computer 102B, and/or smartphone 102C. As one benefit, a user may then write, circle, underline, scribble, or otherwise identify a particular aspect of scene 210A and/or type notes 212A to further annotate scene 210A.

In another embodiment, the underlying content changes from scene 210A to scene 210B. If the user is not taking notes, the presented scene may similarly change from 210A to 210B. However, to facilitate the user who wishes to take notes 212A, and associate notes 212A with scene 210A, even if the underlying presentation has changed to scene 210B, scene 210A is captured and held as an apparent scene while the user takes notes. Once the user has finished, such as by selecting “done” button 208, display 202 is allowed to update to show scene 210B whereby, optionally, new notes 212B may be taken and associated with scene 210B in a similar manner. Annotations may be buffered and/or written to a file for later viewing Annotations may be ordered by the time first seen and/or the time first annotated. Each view in the resulting file may also be associated with a timestamp or other cue into the annotations as a means to enable synchronization with any recording of the original public presentation. In another embodiment, the entire captured presentation layer is saved with the annotations, such that the annotations may be viewed with the presentation as it existed during the annotation, including portions that were not annotated.

In one embodiment, the live content displayed in window 204 is presented on one layer, a real-time presentation layer. Upon the user beginning to take notes, or otherwise indicating a desire to hold the scene, a snapshot of the real-time presentation layer is captured in a private layer as a captured presentation layer. In one embodiment, the captured presentation layer is also the annotation layer, whereas in other embodiments, the annotation layer is distinct from the presentation layer.

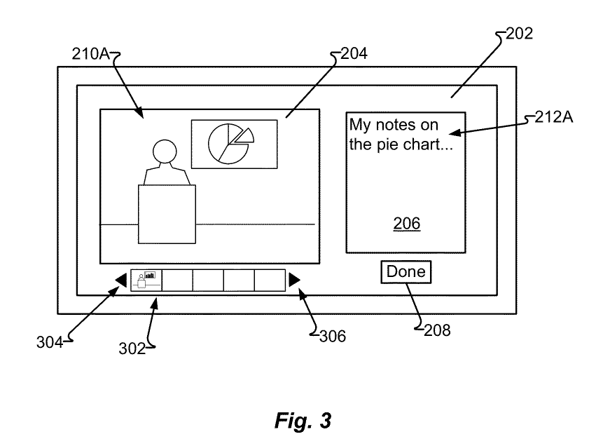

With reference now to FIG. 3, navigation panel 302 will be described in accordance with embodiments of the present disclosure. In one embodiment, as the user is taking notes, or otherwise holding a scene in the captured presentation layer, the underlying live presentation may advance to a new scene. Navigation panel 302 provides an indicator of the advancement of the presentation. Navigation panel 302 may capture thumbnail images, display the time difference between the displayed scene and the underlying presentation, or other indicator of how far the underlying presentation has advanced. In one embodiment, navigation panel 302 captures thumbnail images on a period basis. In another embodiment, the underlying scene in the presentation layer is monitored and when the scene changes, or changes beyond a threshold, a new scene is detected, a second snapshot captured, and presented as another thumbnail image in navigation panel 302. Optionally, the second snapshot may be selected and notes taken and associated with the second snapshot, in a manner similar to the first snapshot.

Navigation panel 302 may also use or incorporate review 304 button, to allow the user to go back to a previous scene, and/or fast forward button 306 to allow the user to advance to the next scene, rejoin the live scene, or push forward to a future scene such as when a complete presentation deck has been pre-shared with the participant. Rejoining the live scene may then cause the captured presentation layer to be visually removed from the client. The users notes on the annotation layer, as associated with a particular scene and captured presentation layer, may be displayed as a component of the thumbnail image of the navigation panel 302 or separately, such as in notepad 206. In yet another embodiment, navigation panel 302 may be used to view the contents of a saved annotation file after the live presentation has concluded.

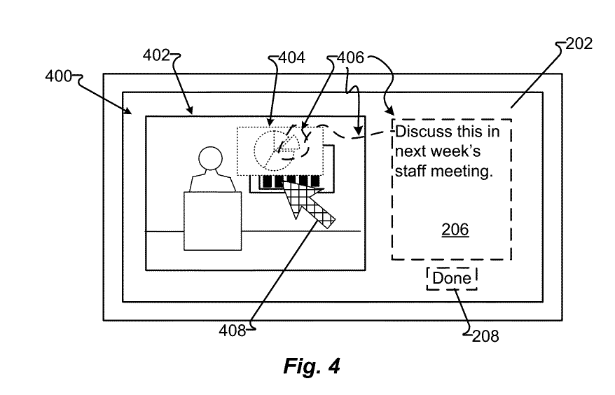

With reference now to FIG. 4, combined image 400 will be described in accordance with embodiments of the present disclosure. In one embodiment, display 202 displays four layers: real-time presentation layer 402 (illustrated as FIG. 4 elements having solid lines), captured presentation layer 404 (illustrated as FIG. 4 elements having dotted lines), annotation layer 406 (illustrated as FIG. 4 elements having dashed lines and text in notepad 206), and presentation public annotation layer 408 (illustrated as FIG. 4 elements in crosshatch, namely pointer 408). In other embodiments, layers may be combined, such as presentation layer 408 with real-time layer 402 and/or captured presentation layer 404 and annotation layer 406. Real-time layer 402 displays the visual content of the webconference as it is delivered. It should be noted that the term “real-time” may include normal signal delays associated with buffering, transmission delays, and other system-induced delays, however, the content of the real-time layer 402 continues unabated.

In one embodiment each of layers 402, 404, 406, and 408 is opaque to entirely obscure any underlying layers or other visual elements. In this embodiment, the otherwise obscured layers may be offset slightly to convey the concept of layers and to facilitate the ability to navigate between layers.

In another embodiment, at least one of layers 402, 404, 406, and 408 is transparent to partially, or entirely, allow the underlying layer or layers to be visible accordingly. In yet another embodiment, at least a first portion of at least one of layers 402, 404, 406, and 408 is transparent, to a first amount, and a second portion is transparent to a second amount which may include being opaque.

The context of real-time presentation layer 402 proceeds regardless of the user's actions or inactions. For example, the visual content of real-time presentation layer 402 may include an image of pie chart and, at a later time, change to include an image of a bar chart. The user indicating an intention to make annotations, causes captured presentation layer 404 to capture an image of the real-time presentation layer 402. The image captured may be an exact replica of the real-time presentation layer 402 content, or a compress, cropped, or other variant whereby a useful portion of the visual content of real-time presentation layer 402 is available to the user for annotating Annotation layer 406 is then operable to receive a user's annotations and, optionally, revive indicia that the user is done with the annotations, such as by selected “done” button 208, selecting the edge of an otherwise obscured layer, or similar indicator.

Optionally, presentation pointer layer 408 may include a pointer or other graphical element under the control of a moderator or webconference participant. While no annotations are taking place, presentation pointer layer 408 may be opaque or have a limited degree of transparency. Once a user beings annotations, presentation pointer layer 408 may be entirely transparent or hidden, have an increased transparency, or be placed directly on top of the real-time presentation layer 402, so as to not visually interfere with the annotation process.

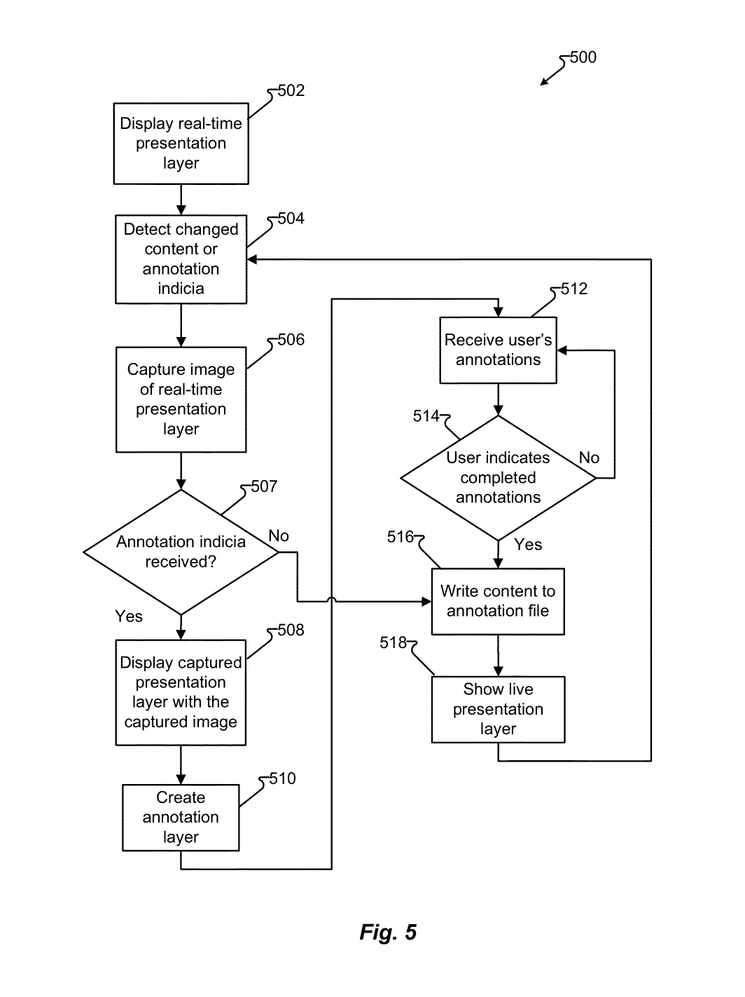

With reference now to FIG. 5, flowchart 500 will be described in accordance with embodiments of the present disclosure. In one embodiment, step 502 displays a real-time presentation in a public real-time presentation layer, such as real-time presentation layer 402. During the real-time presentation, step 504 receives indicia of a substantial change in rendered content in the Public layer or the user's intent to create an annotation. Step 506 then captures an image of the real-time presentation layer. At step 507 if no annotation indicia was received, the captured image may be saved with a timestamp in the local annotation file at step 516, otherwise processing continues to step 508. If the captured image was the result of the user providing indicia of intent to provide an annotation, such as by beginning to annotate the display content, the captured image is displayed on top of, or in place of, real-time presentation layer in preparation for annotation. Step 510 creates an annotation layer, such as annotation layer 406. Optionally, annotation layer 406 may already exist and step 510 opens and/or reveals annotation layer 406. At this point, a user may enter annotations.

Step 512 receives a user's annotations. Step 514 determines if the user has indicated that they are finished with the annotations. Step 514 may be answered affirmatively upon the user expressly indicating completion, such as by selecting “done” button 208, by selecting the handle of the partially obscured live presentation layer, selecting the “rejoin the live stream” button 306, or by a duration of inactivity beyond a previously determined threshold. If step 514 is no, processing returns to step 512. Once completed, step 516 preserves the annotations, which may include a timestamp of when the annotation began. Step 516 may be the writing of annotations from layer 406 to an annotation file. Step 518 closes, or optionally hides captured presentation layer 202 and annotation layer 406. Flowchart 500 may then continue back to step 504. Flowchart 500 loops until cancelled by the user or the presentation ends, whereupon the local annotation file is saved and may further contain a complete time-stamped capture of the local annotations with the webconference presentation material.

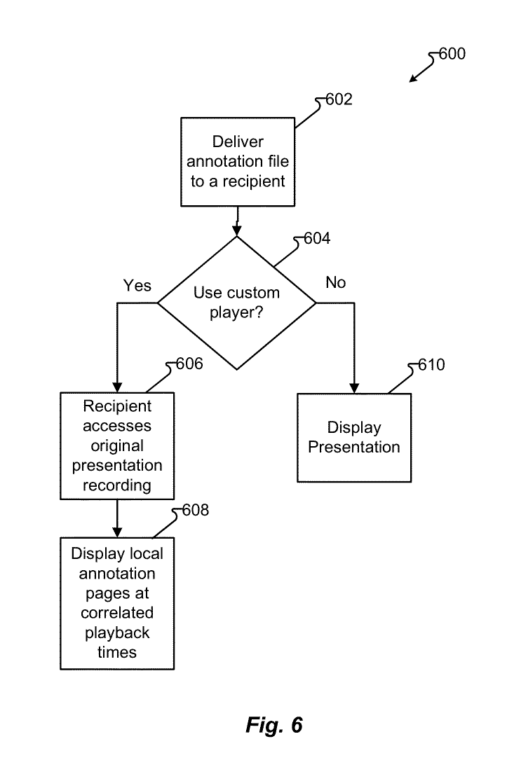

With reference now to FIG. 6, flowchart 600 will be described in accordance with embodiments of the present disclosure. In one embodiment, timestampted annotations (e.g., content of annotation layer 406) are saved in an annotation file. Preferably, the content of the annotation file includes the timestamped content of the captured presentation layer 404 and/or presentation public annotation layer 408. The annotation file may be located on a local machine, such one of devices 102, server 104, and/or other storage medium. The contents of the saved annotation file may itself be a presentation file that may be provided to another party or the same party to view at a later date. Because the presentation file also contains order and/or timestamp metadata, a custom player is able to sync the local images and annotations with other streamed content (such as audio and video recordings) made by server 104. Accordingly, step 602 delivers the saved annotation file to a recipient. Step 602 may comprise any known methods for file transfer, including but not limited to, FTP, email, streaming, etc.

Step 604 determines if the file is to be correlated to a public recording of the webconference and rendered by a custom player, or if standard presentation software will be used. It should be noted that the custom player comprises a presentation player that has been enabled to provide features and functionality described by certain embodiments provided herein. Step 604 may be based upon whether or not the original presentation recording exists and is accessible, whether or not the recipient has access to the custom player, and/or whether or not the recipient desires to review the original recording. If step 604 is no, processing continues to step 610 whereby the contents of the annotation file are presented using standard presentation software, such as a “PDF” viewer.

If step 604 is yes, processing continues to step 606 whereby the recipient accesses the original presentation recording. Step 608 then correlates the timestamps of pages in the annotation file with the playback time of the player, rendering the appropriate page image for any given timecode on the playback clock. The annotation file may comprise the captured presentation image, markers, such as timestamps, or other means to facilitate synchronization of the presentation content with the annotations. In another embodiment, the annotation file may comprise user cues to indicate when a user should advance the annotations from one portion of the presentation to the next.

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor (GPU or CPU) or logic circuits programmed with the instructions to perform the methods (FPGA). These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

Specific details were given in the description to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments were described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

While illustrative embodiments of the disclosure have been described in detail herein, it is to be understood that the inventive concepts may be otherwise variously embodied and employed, and that the appended claims are intended to be construed to include such variations, except as limited by the prior art.

What is claimed is:

1. A method, comprising:
displaying a real-time presentation on a real-time presentation layer, the real-time presentation comprising at least a visual portion;
detecting a user input;
capturing, in response to the detected user input, an image substantially corresponding to the real-time presentation layer and displaying the image in an annotation layer;
enabling a user to provide annotations on the annotation layer; and
displaying the annotation layer on top of the real-time presentation layer.

2. The method of claim 1, wherein the annotation layer further comprises a captured image sublayer and displays the image therein, the captured image sublayer being presented in front of the real-time presentation layer.

3. The method of claim 1, wherein the user input is indicia of an annotation.

4. The method of claim 3, wherein the indicia of an annotation is at least a start of an annotation.

5. The method of claim 1, further comprising, increasing the opacity of the annotation layer relative to the real-time presentation layer upon receiving the user input.

6. The method of claim 1, further comprising, saving the contents of annotation layer in a data repository.

7. The method of claim 1, further comprising:
receiving a public presentation annotation associated with the real-time presentation; and
displaying the public presentation annotation in a public presentation annotation sublayer.

8. The method of claim 6, wherein the public presentation annotation sublayer in front of the real-time presentation layer.

9. A computing system, comprising:
a network interface operable to receive a real-time presentation comprising at least a visual portion;
a video display component;
a user input component; and
a processor operable to display the visual portion in a real-time presentation layer, capture an image substantially corresponding to the real-time presentation layer in response to a user input on the user input component, display the image in an annotation layer, receive user inputs associated with an annotation on the annotation layer, and display the annotation layer in front of the real-time presentation layer.

10. The system of claim 8, wherein the annotation layer further comprises a captured image sublayer and the processor is further operable to displays the image therein with the captured image sublayer presented in front of the real-time presentation layer.

11. The computer system of claim 8, wherein the processor is further operable to capture the image of the real-time presentation layer upon receiving the user input associated with the annotation.

12. The computer system of claim 10, wherein the processor is further operable to increasing the opacity of the captured presentation layer upon receiving the user input on the user input component.

13. The computer system of claim 11, wherein:
the network interface is further operable to receive a public presentation annotation associated with the real-time presentation; and
the processor is operable to display the public presentation annotation within the real-time presentation layer.

14. The computer system of claim 10, further comprising, a data storage operable to save the content of the annotation layer.

15. The computer system of claim 13, wherein the data storage is further operable to save a timestamp associated with a portion of the annotation layer.

16. The computer system of claim 14, wherein the data storage is further operable to save metadata associating a portion of the annotation layer with a portion of the real-time presentation layer.

17. A non-transitory medium having thereon instructions that when read by a machine cause the machine to:
display a real-time presentation on a real-time presentation layer, the real-time presentation comprising at least a visual portion;
detect a user input;
capture, in response to the detected user input, an image substantially corresponding to the real-time presentation layer and displaying the image in an annotation layer;
enable a user to provide annotations on the annotation layer; and
display the annotation layer on top of the real-time presentation layer.

18. The instructions of claim 16, wherein the annotation layer further comprises a captured image sublayer and displays the image therein, the captured image sublayer being presented in front of the real-time presentation layer.

19. The instructions of claim 16, wherein the detected user input is an input associated with creating an annotation.

20. The instructions of claim 16, further comprising instructions to save the content of annotation layer in a data repository.
